(19) United States
(12) Patent Application Publication
(10) Pub. No.: US 2021/0114641 A1
(43) Pub. Date: Apr. 22, 2021

(54) DETACHABLE PORTABLE WHEELBARROW

(71) Applicant: STINE CHENGE, GRAND RAPIDS, MI (US)

(72) Inventor: STINE CHENGE, GRAND RAPIDS, MI (US)

(21) Appl. No.: 16/657,459

(22) Filed: Oct. 18, 2019

(51) Int. Cl. B62B 1/18

(52) U.S. Cl. CPC B62B 1/18

(57) ABSTRACT

This invention generally relates to a wheelbarrow that can easily be assembled and detached for ease of movement and storage. Thus, this wheelbarrow design includes common components of a wheelbarrow but it's characterized by the presence of a series of telescoping tube frames that form the base structure of the wheelbarrow, a pair of legs that are attached to this base telescoping tube frames structure by a joint mechanism, allowing the legs to swing or fold under the tray and back to a designated standing position. The wheelbarrow of this invention is further characterized by the presence of thumbscrews positioned on various sections of the telescoping tube frames, to enable a quick and easy attaching, and detaching of the wheelbarrow into three main sections for ease of movement, storage or reassembling to form a fully functioning wheelbarrow.

### BACKGROUND OF THE INVENTION

### 1. Field of the Invention

This invention generally relates to wheelbarrows. More particularly, this invention relates to a wheelbarrow that can easily be assembled and detached for ease of movement and storage.

### 2. Description of the Prior Art

A wheelbarrow generally includes a tray, a wheel and tire, a pair of legs, a frame to which the wheel, tray, and the pair of legs are attached, and the frame extends outward from the tray to form a set of handles.

A Wheelbarrow may come already assembled from the manufacturer or disassembled and put into packaging with detailed instructions on how to assemble it. This assembly usually requires a set of tools and once assembled the wheelbarrow usually remains assembled throughout its lifespan with any disassembly becoming a very tedious task requiring a set of tools.

The wheelbarrows that do get disassembled, the parts can be numerous and not easily put back together to form a fully functioning wheelbarrow.

This means that most wheelbarrows, once assembled are never again disassembled making them bulky, unable to fit into smaller spaces. It also means most wheelbarrows are difficult to easily transport when fully assembled in their fully functioning state.

As a result many wheelbarrows spend a lot of time outside exposed to harsh weather and outdoor elements.

Accordingly, it is an object of the present invention to provide a wheelbarrow that can easily be assembled and detached for ease of movement and storage, and to this end my design consists of a combination and arrangements of parts to be hereinafter described and claimed.

### SUMMARY OF THE INVENTION

My wheelbarrow design includes a tray, a wheel with tire, braces, and is further characterized by the presence of a series of telescoping tube frames, a pair of legs attached to a section of the telescoping tube frames by a joint mechanism, allowing the legs to swing under the tray and back to a designated standing position, and thumbscrews positioned on various sections of the telescoping tube frames, to enable a quick and easy attaching, and detaching of the wheelbarrow into three main sections for ease of movement, storage or reassembling to form a fully functioning wheelbarrow.

### IN THE DRAWINGS

FIG. 1 is a perspective view of a wheelbarrow showing my new design;

FIG. 2 is a side elevation of the wheelbarrow in a fully functioning state. (Left and Right sides are identical)

FIG. 3 is a partial perspective view showing a section of the telescoping tube frames where the tray (not shown) is attached, and the legs.

FIGS. 4(a) and 4(b) are side elevations of a section of the wheelbarrow showing a design of the tray attached to a section of the telescoping tube frame, and legs.

FIG. 5(a) is a side elevation and FIG. 5(b) is a perspective view, both showing the wheel, attached to a section of the telescoping tube frame.

FIG. 6 is a perspective view of the detachable wheelbarrow handles

### DETAILED DESCRIPTION OF THE EMBODIMENT

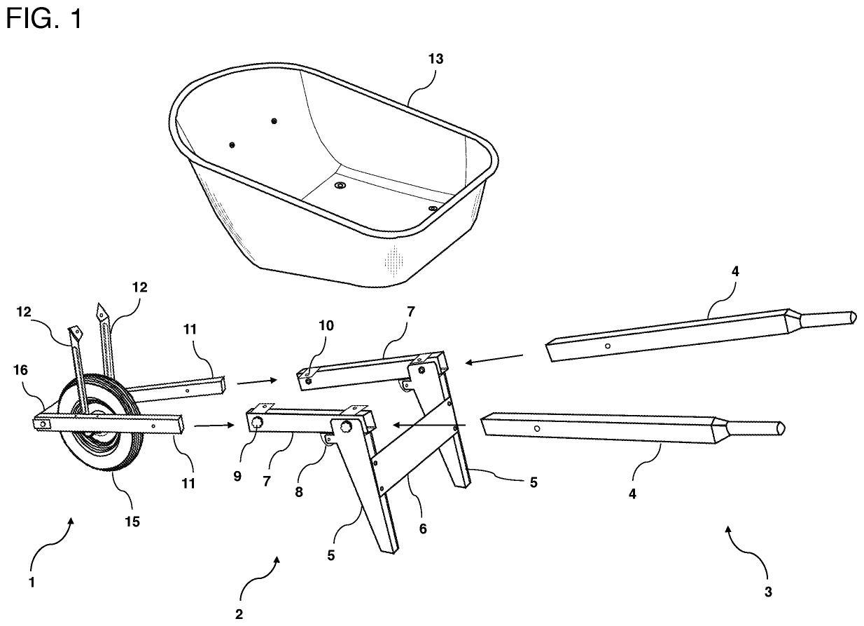

In FIG. 1, a perspective view of a wheelbarrow according to an embodiment of the present invention is shown. The wheelbarrow includes the wheel frame assembly 1, which consists of, a wheel with tire 14, front braces 12 that support the tray 13, telescoping tube frames 11, and a front guard 15.

The wheelbarrow in FIG. 1 also includes the tray frame assembly 2, which consists of, a tray 13, telescoping tube frames 7, a pair of legs 5 that are connected together by a brace 6. The legs are attached to 7 by a joint mechanism 8. The tray 13 is attached to 7 by aligning the bolt openings 10 with the tray bolt openings 16 and holding it in place with bolts and nuts (not shown). 7 further has at least one thumbscrew 9 to enable a quick and easy attaching/detaching of the wheel frame assembly 1 and the handles 4, also referred to in this document as the handle grip assembly 3, from the tray frame assembly.

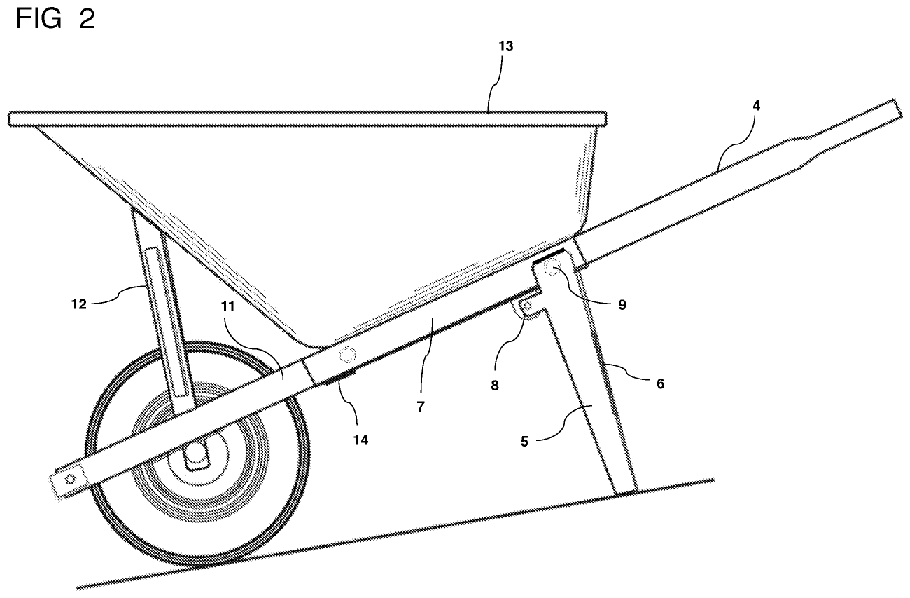

The wheel frame assembly 1 and the handle grip assembly 3 are designed to be assembled separately as stand alone sections that can be attached to the tray frame assembly 2, by sliding the telescoping tube frames 11 of the wheel frame assembly into the front end of the telescoping tube frame 7 of the tray frame assembly 2 and aligning the wheel braces bolt holes 16 to the tray braces nut holes 17, and further sliding the telescoping frames 4 of the handle grip assembly 3 into the rear of the telescoping tube frames 7 of the tray frame assembly 2 and fastening the thumbscrews 9 to form a complete wheelbarrow as shown in FIG. 2.

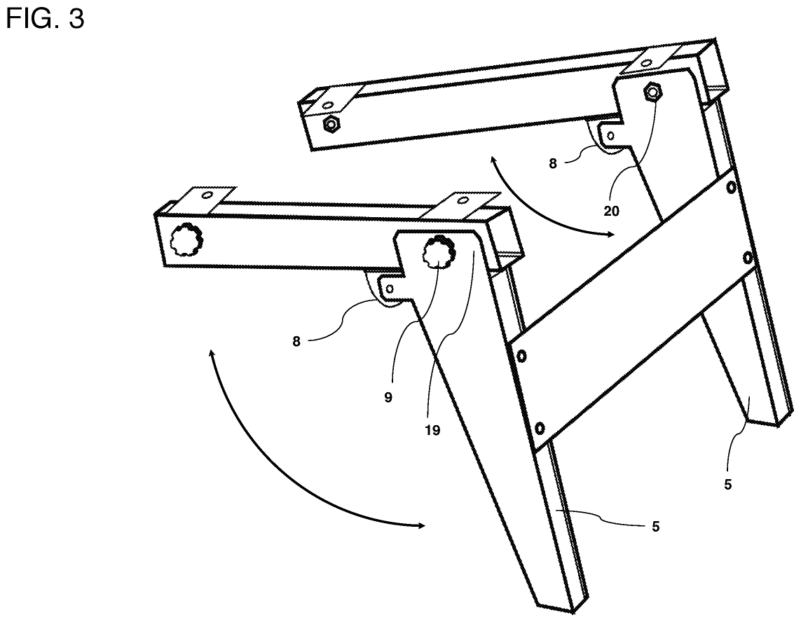

FIG. 3 is a perspective view of the tray frame assembly 2 (without the tray 13) showing the design and functionality. The legs 5 are designed to have a side guide 19 at the top where the telescoping tube frame 7 sits when the legs 5 are locked into the standing position by the thumbscrews 9. This design ensures there is added support and stability of the wheelbarrow by preventing leaning from side to side. These side guides 19 also serve a secondary purpose, as the entry and exit point 20 for the thumbscrew 9 used to lock the handle grip assembly 3 and the legs into place are located on it.

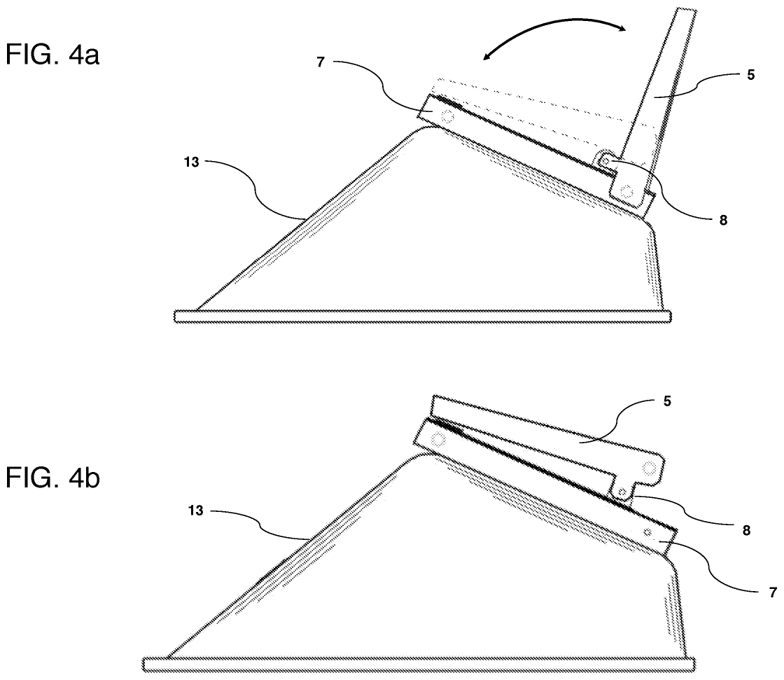

The legs 5 are attached to the telescoping tube frame 7 of the tray frame assembly 2 by a joint mechanism 8. The joint mechanism 8 allows the legs to swing under the tray frame assembly 2 and back to a designated standing position. The arrows in FIGS. 3 and 4(a) indicate the direction the legs 5 follow when swinging and FIG. 4(b) is a side elevation of the tray frame assembly 2 when the legs are fully swung under it.

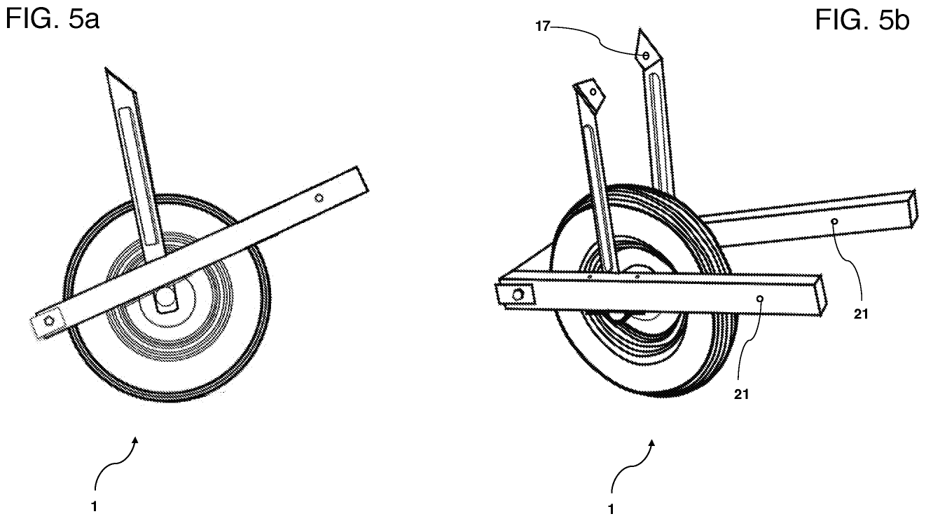

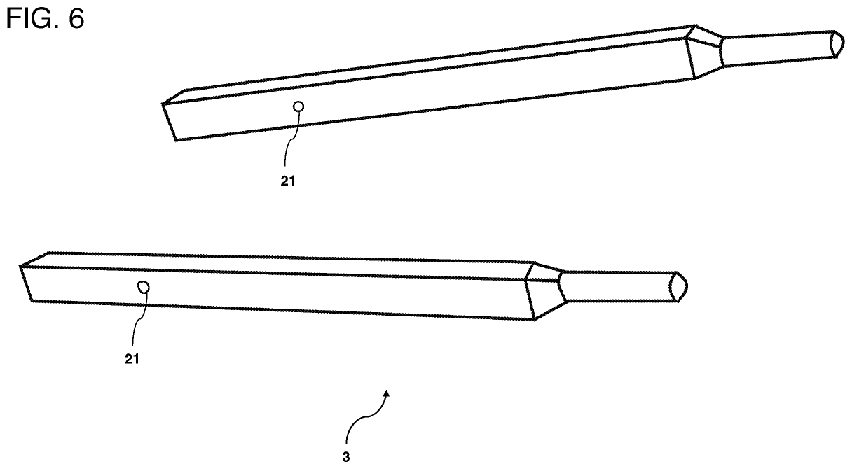

It is an object of this invention that when the wheelbarrow is fully assembled as shown in FIG. 2, it can be detached by loosing and removing, without the aid of any tool, the thumbscrews 18 that lock in place the wheel braces 12 to the tray 13, and the thumbscrews 9 that lock in place the telescoping tube frames 11 of the wheel frame assembly 1 and the telescoping tube frames 4 of the handle grip assembly 3, into the tray frame assembly 2, enabling the wheelbarrow as shown in FIG. 2 to be easily and quickly detached into three main parts, to include the wheel frame assembly as shown in FIGS. 5(a) and 5(b), the tray frame assembly FIG. 4(b) and the handle grip assembly FIG. 6 (showing thumbscrew openings 21) for ease of storage or movement, and ease of reassembling, without the use of any tools, to form a fully function wheelbarrow as shown in FIG. 2.

I claim:

1. A wheelbarrow comprising a wheel, front braces, a tray, a pair of legs, a pair of handles, wherein said parts and components are connected and held together by a series of telescoping tube frames,
wherein the top of each front brace is attached to the tray by at least one thumbscrew, to enable subsequent attaching and detaching the front braces from the tray in a quick and timely manner, without the aid of tools,
wherein each of said telescoping tube frames facilitates a quick and easy attaching of one telescoping tube frame into another in a manner that forms a single frame structure for the wheelbarrow, each of said telescoping tube frames comprising at least one thumbscrew fastened through aligned openings in the combined telescoping tube frames, without the aid of tools, to lock them in place and prevent the unintended disintegration of the combined telescoping tube frame structure of the wheelbarrow,
wherein each of said telescoping tube frames consist of a combination or arrangement of wheelbarrow parts in a manner that when the combined telescoping tube frames are detached, without the aid of any tool, from one another by removing the thumbscrews, there are at least two or more sections of the wheelbarrow, wherein at least one section has the wheel and front braces attached to it, another has the tray and legs attached to it and another section is a pair of handles,
and wherein each section can be easily moved, stored or be reattached using only thumbscrews and no tools, to form a fully functioning wheelbarrow.

2. A wheelbarrow according to claim 1, wherein the pair of legs are attached to the section of the telescoping tube frame where the tray is mounted, by a joint mechanism, and each said joint mechanism allows the legs to swing or fold under the telescoping tube frame during the detaching of the wheelbarrow, so it can be easily moved or stored,
and wherein during reattachment, each said joint mechanism allows the legs to return back to the designated standing position,
and wherein the handles of the wheelbarrow are inserted into the rear of the telescoping tube frame where the tray and legs are mounted, and the thumbscrew openings on the handles are aligned with those of the telescoping tube frames and of the legs now in the standing position, so the legs and the handles could be locked in place with at least one thumbscrew, without the aid of any tool, to form a fully functioning wheelbarrow.
